(19) United States
(12) Patent Application Publication
(10) Pub. No.: US 2005/0226488 A1
(43) Pub. Date: Oct. 13, 2005

(54) Inspection system for blister packages

(76) Inventors: Paud Barry, Gracedieu (IE); Michael W. Murphy, Woodstown (IE); Eoin Roche, Waterford (IE)

Correspondence Address: Bausch & Lomb Incorporated, One Bausch & Lomb Place, Rochester, NY, 14604-2701, US

(21) Appl. No.: 10/813,860

(22) Filed: Mar. 31, 2004

(51) Int. Cl. G06K 9/00

(52) U.S. Cl. 382/141

(57) ABSTRACT

An inspection system for inspecting the seal area and/or volume fill level of a blister package comprising an image pick-up device and providing an image pick-up device; presenting the blister package with cover adhered thereto to the field of view of said image pick-up device; imaging and determining the grey level of said seal area and comparing the imaged grey level to a predetermined grey level value; and passing the blister package inspection if the imaged grey level is substantially the same as the predetermined grey level value or rejecting the blister package inspection is the imaged grey level is not substantially the same as the predetermined grey level value.

### BACKGROUND OF THE INVENTION

The present invention relates to inspection systems in a production line. More particularly, the present invention relates to an inspection system for inspecting the seal area and/or solution volume of a blister package containing an ophthalmic lens in solution.

Ophthalmic lenses such as contact lenses are commonly packaged in small containers referred to as blister packages comprising a disposable plastic container having a well for containing a single lens in a quantity of storage solution (e.g., saline). A foil lidstock is applied to the blister package and sealed thereto, usually around the perimeter of the well containing the lens and solution. The foil lidstock may comprise a laminate, for example, a first polypropylene layer which is laid against the blister followed by a foil layer on which a paint layer may be applied for graphic application followed by a top lacquer layer. Sealing the lidstock to the blister package may be carried out by the application of heat which seals the poylpropylene layer to the plastic blister. The sealing process is carried out in an automated fashion such that many blister packages may be sealed very quickly. Although automation increases productivity of the production line, errors may happen during the sealing process which may go undetected. Sealing errors may include, for example, bubbles, voids, particulate matter, and oversealing. Any of these errors can cause an imperfect seal leading to lens contamination or leakage of the storage solution from the blister whereupon the blister and lens must be discarded. Manual inspection has been carried out in the past, however manual inspection is prone to human error and is time and labor intensive. It is therefore desirable to have a robust sealing process which includes the detection of seal errors so that the blister having the imperfect seal can be discarded before it is shipped to a consumer. It is also desirable to automatically inspect the volume fill level of the storage solution in the blister to ensure the proper amount of storage solution has been dispensed in the blister package.

### SUMMARY OF THE INVENTION

In a first aspect, the present invention provides an inspection system which is operable to detect errors in the seal area of a lidstock applied to a blister package. The inspection system includes an image pick-up device (e.g., a camera) directed toward the seal area of a blister package. The seal area is typically the area surrounding the recessed well which houses the lens and storage solution although it may also include a larger flange area surrounding the well. The seal around the perimeter of the well, typically referred to as a “racetrack” in the art, must be a complete seal or else the lens may become contaminated and solution may leak from the blister package which must then be discarded. The inspection system applies a pattern to the racetrack, for example, small square or rectangle boxes placed in succession around the complete racetrack. A software utility connected to the image pick-up device checks the pattern for a predetermined amount or range of grey level within the boxes. A difference from a threshold grey level is treated as an error. This is because a good seal will have a measurable grey level value or range caused by the correct application of heat, pressure and time to the two materials being bonded together (i.e., the lidstock and the blister racetrack). If the detected grey level is different than the threshold value or range, the software utility then calculates the size of the detected error. If the size is outside the acceptable value or range, that blister is targeted for disposal.

In a second aspect of the invention, an inspection system is provided for inspecting the volume (fill level) of storage solution in a sealed blister package. The vision system includes an image pick-up device (e.g., a camera) which is operable to detect the solution level within a blister package. In one embodiment, the blister package may be presented vertically to the image device. If the detected solution level falls outside a predetermined accepted amount or range, that blister package is targeted for disposal. In a particularly advantageous embodiment of the invention, the seal inspection system is integrated with the volume inspection system.

### BRIEF DESCRIPTION OF THE DRAWING

FIG. 1 is a perspective view of a representative blister package showing the cover peeled partly off;

FIG. 2 is a cross-sectional view of the blister package as taken generally along the line 2-2 of FIG. 1 except the cover is sealed to the blister package;

FIG. 3 is a bottom plan view of the blister package;

FIG. 4 is an enlarged cross-section view of the cover showing the individual layers thereof;

FIG. 5 is a schematic view of the inspection system set-up of the present invention;

FIG. 6 is a bottom plan view of a blister package showing a consecutive array of white ROIs on part of the seal area of a blister package undergoing inspection;

FIG. 7 is the view of FIG. 6 showing one type of seal error detected by the inspection system;

FIG. 8 is the view of FIG. 7 showing yet another type of possible seal error;

FIG. 9 is a bottom plan view of a blister package showing inspection of the volume fill level of the package; and

FIG. 10 is the view of FIG. 9 showing a different fill level.

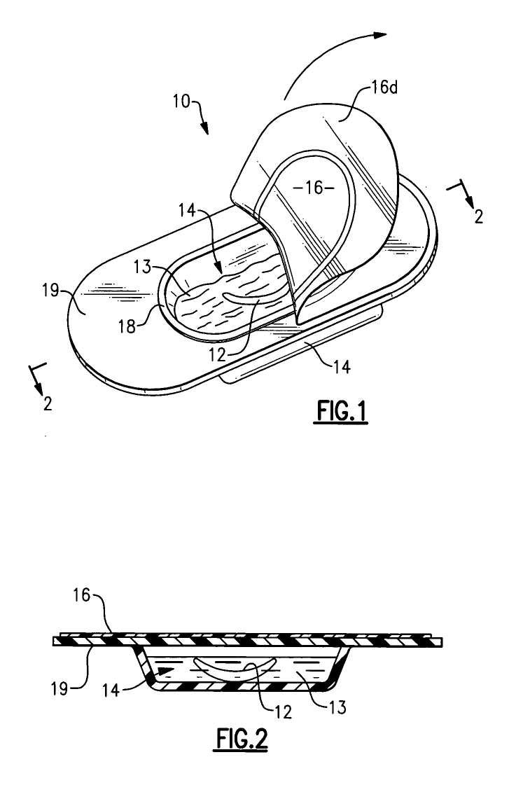

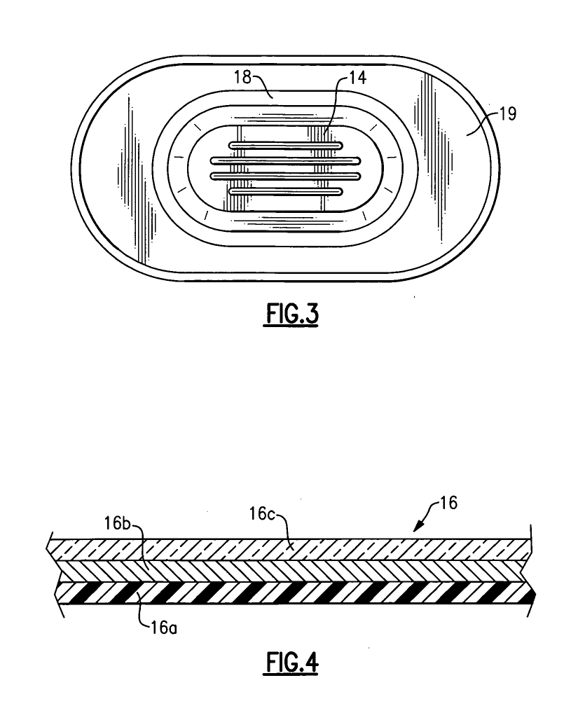

### DETAILED DESCRIPTION

Referring to the drawing, there is seen in the Figures a representative blister package 10 used for packaging a hydrophilic contact lens 12. Blister 10 is made of a disposable plastic (e.g., polypropylene) and includes a recessed well 14 wherein lens 12 is placed with a quantity of storage solution 13 (e.g., saline). A cover 16 is sealed about the well 14. Cover 16 is typically a foil laminate having a first base layer which will bond to the blister package upon application of heat and pressure. As seen in FIG. 4, the first, base layer 16a may be polypropylene, for example, followed by a foil layer 16b and a protective lacquer top layer 16c. Cover 16 is sealed at least about the perimeter or “racetrack” 18 of the well 14. Racetrack 18 may be flush or raised relative to the flange area 19 surrounding the racetrack 18. Cover 16 may further include an unsealed gripping portion 16d to enable a user to easily grasp and peel cover 16 from blister 10 to access the lens 12 therein.

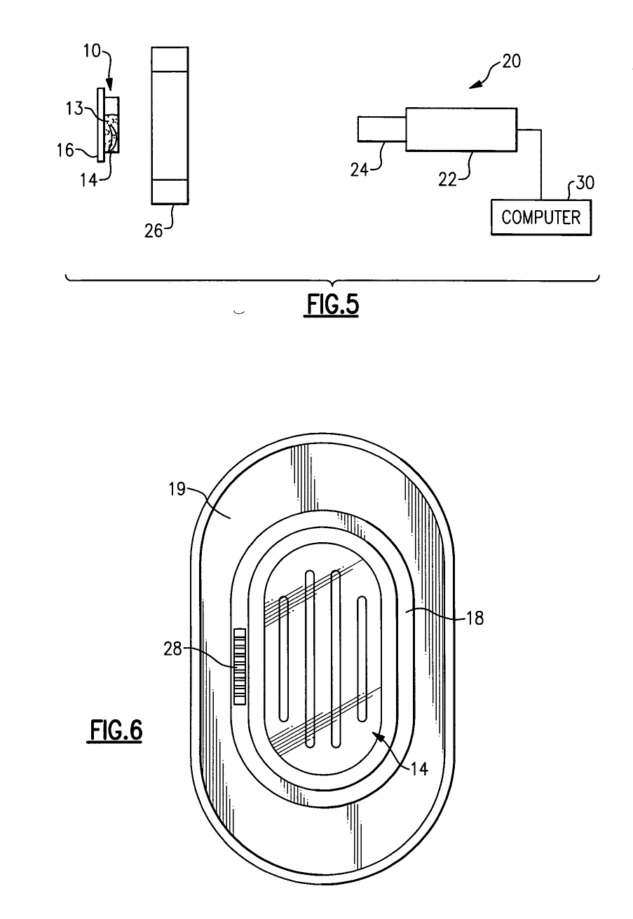

As seen in FIG. 5, the inspection system station 20 of the invention is shown schematically and includes an image pick-up device (e.g., a DSL5000 camera) 22 having a lens 24 (e.g., a 35 mm lens) directed at a blister package 10 to be inspected. A low angle light ring 26 is positioned between blister package 10 and image pick-up device 22. Blister package 10 has previously had a lens 12 and storage solution 13 deposited in well 14 thereof and a cover 20 sealed thereto about racetrack 18. The sealing station (not shown) may comprise a heat sealing station which applies heat and pressure to the cover at the location of the racetrack 18, thereby sealing the well 14 and its contents. Prior to shipping to the consumer, the blister packages will undergo sterilization to ensure the lens is sterilized for safe application to the user's eye. It is therefore apparent that the sealing process must ensure a seal that will not compromise the sterility of the lens in the blister package. Thus, in a first aspect of the invention, inspection station 20 is provided for inspecting the seal area (racetrack) 18 of the blister package. Should the inspection indicate problems with the seal, the blister is targeted for disposal.

The inspection station image pick-up device 22 includes means for projecting ROIs (regions of interest) onto racetrack area 18 of the sealed blister 10. The ROIs labled 28 in FIG. 6 comprise small square or rectangular boxes which, although only several are shown in the figure, extend in a sequential array around the full length of the racetrack 18. The image pick-up device 22 images the blister 10 and racetrack 18 and connects to a computer 30 having inspection software which analyzes the image picked up by image pick-up device 22. Suitable inspection software and harware for use with the present invention includes Inspection Builder 3.1 by PPT Vision System.

To get a baseline reading, a seal known to be good is either directly input or measured by image pick-up device 22 and stored in computer 30. The image pixels are analyzed for their grey level (contrast) and this becomes the accepted baseline number. Upon receiving a blister package for inspection, the image pick-up device 22 images the blister racetrack 18 and the software utility examines the ROIs to determine their grey level. This reading is compared to the baseline number in the computer and if it is within an acceptable deviation range, the blister package is passed for seal inspection. If instead a grey level is detected outside the acceptable deviation range, the software utility next examines the size of the area outside the acceptable deviation range. If the area is of a size which is not acceptable, the blister package is targeted for disposal. If instead the size is deemed within acceptable parameters, the blister package is passed for seal inspection. It is noted that the second analysis step wherein the area size is calculated and compared to an acceptable value previously input into the computer may be seamlessly integrated into the step of grey level analysis by the computer. The second analysis may also be eliminated if desired should the grey level analysis be determined sufficient to determine failed blister packages.

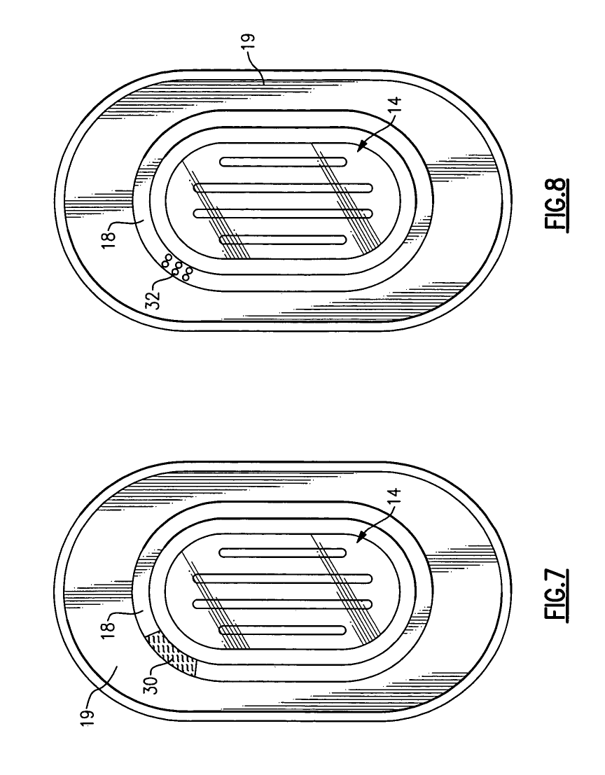

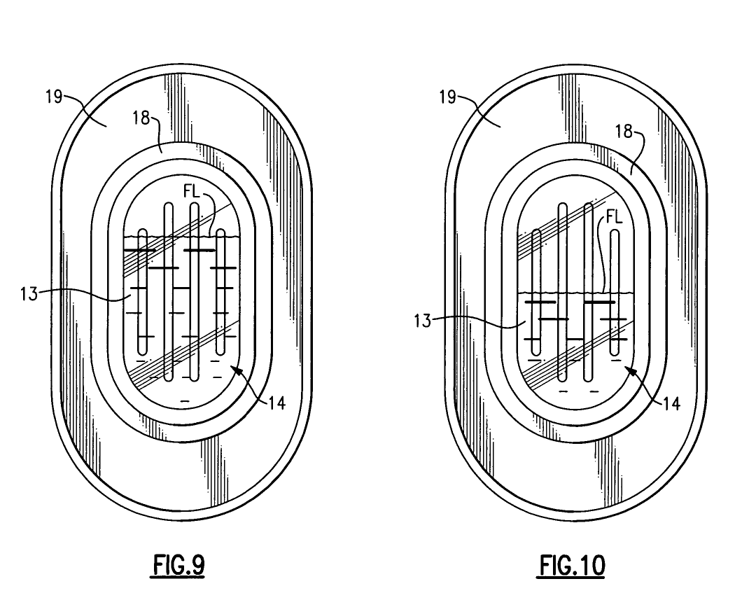

It is noted that the blister package may be oriented vertically as shown in FIG. 5 during inspection. The bottom of well 14 is directed toward the image pick-up device. Since the blister package is translucent, the image pick-up device can see through the package to racetrack 18. The heat sealing process causes a certain grey level to appear at the racetrack 18 where the cover 20 has adhered to the blister racetrack 18. This grey level contrasts with the grey level appearing at unsealed areas of the cover 20 (i.e., areas both inside and outside racetrack 18). A good seal will have a certain grey level all around the racetrack 18. Measuring this grey level thus enables the system to compare each blister undergoing inspection to the known acceptable grey level. Grey levels outside an acceptable deviation range will be rejected. For example, FIG. 7 shows a representative blister package 10 undergoing inspection where a seal error in the form of a seal void is indicated at reference numeral 30. This void in the seal area would likely cause leakage of the storage solution from well 14 and contaminate the lens 12 therein. Inspection system 20 will read this area as a difference in acceptable grey level and target this blister package for disposal. The system may either sound a bell to alert a worker for removal of the failed package or the system may send a signal ordering automated machinery to pull the blister form the production line. FIG. 8 shows another type of seal error in the form of air bubbles 32 captured between cover 20 and racetrack 18. Again, this type of error would likely compromise the seal integrity and contaminate lens 12 therein and the inspection system would target the blister for disposal. As discussed above, a second analysis step may be performed wherein the area size of the grey level detected to be outside acceptable parameters is calculated and compared to an acceptable area value previously input into the computer.

In another aspect of the invention, the fill level (volume) of storage solution 13 may also be inspected by inspection system 20. The image pick-up device 22 reads the contrast difference at the fill line FL which is indicative of the solution fill level. If the fill level is detected to be below the threshold level, that blister is target for disposal. In an advantageous embodiment, the volume inspection is done together with the seal inspection.

It is noted that the blister packages may be presented to the inspection station 20 in automated succession and may be handled by a conveyor and/or a fixturing device which presents the blister package at the correct orientation to the image pick-up device 22.

Although the invention has been described herein in relation to a particular blister package design, it is understood that the invention may be used with other blister package designs.

1. A method of inspecting the seal area between a blister package and a cover, said method comprising the steps of:
a) providing an image pick-up device;
b) presenting the blister package with cover adhered thereto to the field of view of said image pick-up device;
c) imaging and determining the grey level of said seal area and comparing the imaged grey level to a predetermined grey level value; and
d) passing the blister package inspection if the imaged grey level is substantially the same as the predetermined grey level value or rejecting the blister package inspection is the imaged grey level is not substantially the same as the predetermined grey level value.

2. The method of claim 1 and further comprising the step of projecting a series of ROIs on the imaged seal area and wherein imaging of the grey level of the seal area occurs within each ROI.

3. The method of claim 2 and further comprising the step of calculating the size of an imaged grey level that is not the same as the predetermined grey level value and passing the blister package inspection if the size is substantially the same or smaller than a predetermined acceptable size or rejecting the blister package inspection if the size is greater than the predetermined acceptable size.

4. The method of claim 1 and further comprising the step of imaging the fill level of solution held in the blister package and comparing the imaged fill level with a predetermined acceptable fill level and passing the blister package if the imaged fill level is substantially the same as the predetermined accepted fill level or rejecting the blister package if the imaged fill level is less than the predetermined accaptable fill level.

5. The method of claim 4 wherein said blister package is oriented vertically during said inspection.

6. A method of inspecting the fill level of a solution in a sealed blister package, said method comprising the steps of:
a) providing an image pick-up device;
b) presenting the blister package to the field of view of said image pick-up device;
c) imaging and determining the fill level of the solution within the blister package and comparing the imaged fill level to a predetermined fill level value; and
d) passing the blister package inspection if the imaged fill level is substantially the same as the predetermined fill level value or rejecting the blister package inspection is the imaged fill level is not substantially the same as the predetermined fill level value.

7. The method of claim 6 wherein said blister package is oriented vertically with respect to said image pick-up device.
